(19) United States
(12) Patent Application Publication
(10) Pub. No.: US 2012/0303518 A1
(43) Pub. Date: Nov. 29, 2012

(54) METHOD AND SYSTEM FOR DISTRIBUTING AND PAYING FOR CONTENT ON SOCIAL NETWORKS

(76) Inventors: Miroslav Sarbaev, San Francisco, CA (US); Anna Nikulina, San Francisco, CA (US); Artem Stemkovski, San Francisco, CA (US); Alson Remmington Kemp, III, San Jose, CA (US); Eugene Warshavsky, San Francisco, CA (US)

(21) Appl. No.: 13/377,820

(22) PCT Filed: Jun. 14, 2010
(86) PCT No.: PCT/US2010/038543

§ 371 Date: Aug. 15, 2012

Related U.S. Application Data
(60) Provisional application No. 61/186,797, filed on Jun. 12, 2009.

(51) Int. Cl. G06F 15/16; G06Q 20/22

(52) U.S. Cl. 705/39; 709/204

(57) ABSTRACT

Copyrighted content on a first social network is downloaded by way of an application running on a second social network. Users of the second social network may share the copyrighted content with other users of the second social network. From the second social network, users may also pay creators of the copyrighted content by way of an electronic payment systems.

This application claims the benefit of U.S. Provisional Application No. 61/186,797 filed Jun. 12, 2009, which is hereby incorporated by reference.

### BACKGROUND

A need exists for a method and system for distributing and paying for content on social networks.

### SUMMARY

A method for distributing content on social networks comprises providing copyrighted content on a first social network, executing an application on a second social network, and downloading the copyrighted content by way of the application on the second social network.

### BRIEF DESCRIPTION OF THE DRAWINGS

FIG. 1 shows a system for distributing and paying for content.

FIG. 2 shows a method for distributing and paying for content.

FIG. 3 shows a method for performing a step of paying a content creator.

FIG. 4 show an exemplary webpage shown to a user of a second social network with content of a first social network displayed.

FIG. 5 shows an exemplary screenshot of a webpage displayed to a user of a second social network.

### DETAILED DESCRIPTION

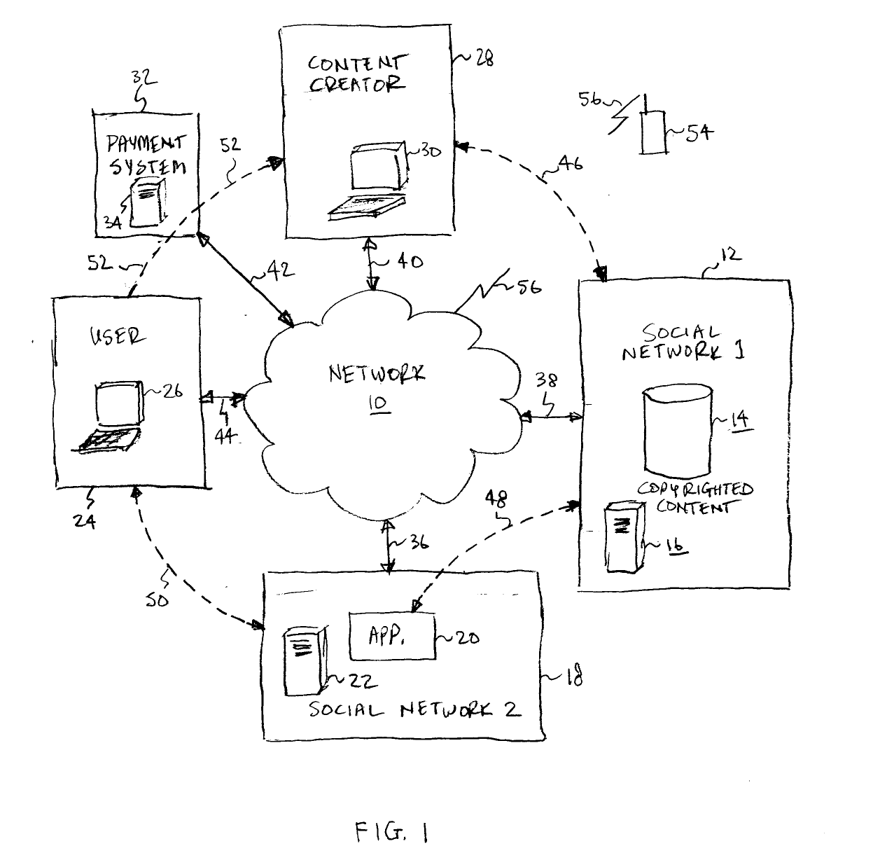

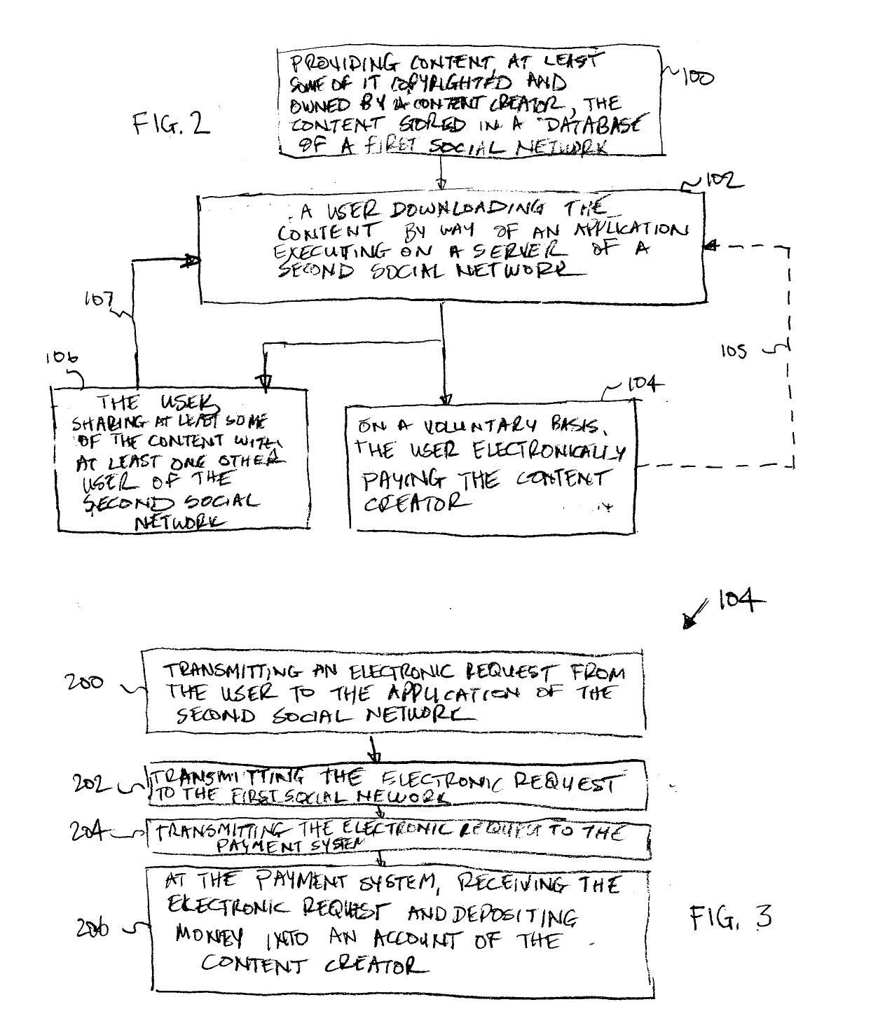

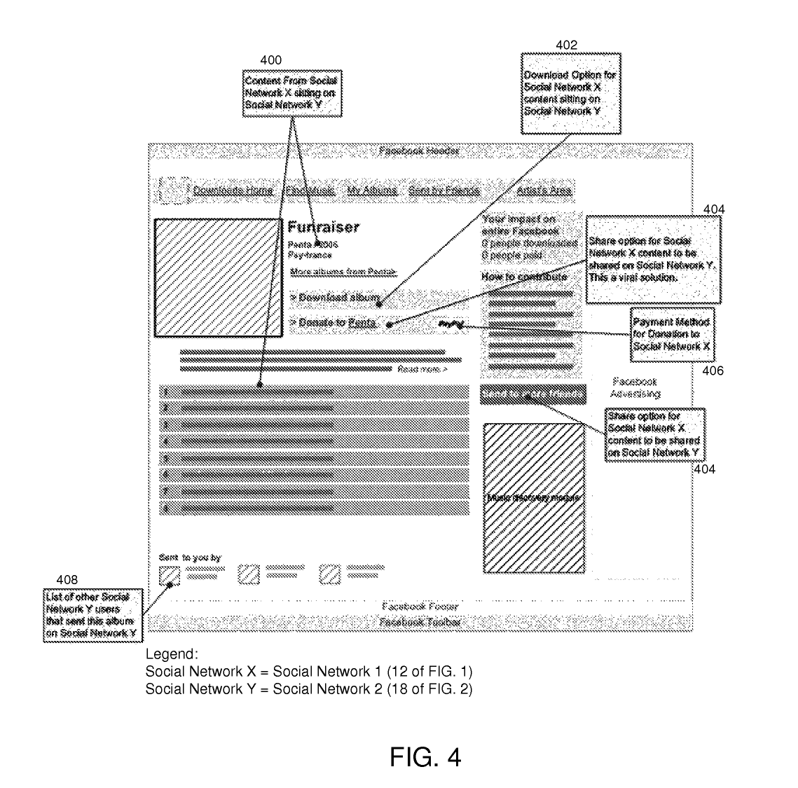

FIG. 1 shows a system for distributing and paying for content. Content includes any material that can be digitally stored and transferred via a network. Examples of content include audio, video, still images, and computer executable code. Content also includes information about the availability of audio, video, images, computer executable code, and the like. Content further includes information such as metadata for audio, video, images, computer executable code, and the like. The content is transferred via a network 10. Network 10 may be a wired network such as the internet, or a wireless network operable to transfer digital data, such as a Global System for Mobile communications (GSM) network, an IEEE 802.xx network, and the like.

There may be a variety of devices in communication with the network 10 such as personal computers (26 and 30) and servers (16 and 22). Other devices such as wireless device 54 may be in communication 56 with the network 10. Examples of wireless devices include smart phones, iPhones, laptop computers, cell phones, PDAs, and the like. These devices may comprise a content creator 28 or a user 24, both of which will be disclosed below. Therefore, when disclosing communications to and from the content creator 28, the user 24, and other elements of FIG. 1 it is understood that the communications can be wireless communications.

A user 24 and a second social network 18 are in communication 50 via the network. Dashed lines 50, 52, 46, and 48 are shown to indicate that various elements of FIG. 1 are in communication. However, all elements are in communication via the network 10. For example, dashed line 50 indicates that user 24 is in communication with second social network because user 24 communicates (arrow 44) with network 10, and second social network 18 communicates (arrow 36) with network 10. Similarly, dashed line 48 indicates that first social network 12 and second social network 18 are in communication with each other (network 10, arrow 38, and arrow 36).

Second social network 18 may be any social network, such as a large social network with hundreds of thousands or millions of users. Examples of a large social network include MySpace, Facebook, Vkontakte, Twitter, and Livejournal. It is well understood by those having ordinary skill in that art how a user 24 and a second social network 18 communicate and how second social network 18 operates. It is also understood that, while only one user 24 is shown, there may be a multiplicity of users in communication with the network 10.

First social network 12 comprises a database 14 which comprises copyrighted content, such as music, album art, and optionally non-copyrighted content. First social network may have some of the same functionality of second social network 18. For example, first social network may be a social network for sharing music, such as kroogi.com.

The copyrighted content 14 is provided by one or more content creators 28. The content creator 28 is in communication (46) via the network 10 and links 40 and 38. After an account is created for or by the content creator, the content creator 28 may upload content, such as music, to the social network. The content is stored in database 14.

First social network 12 and second social network 18 are in communication (48) via network 10 and connections 38 and 36. An application 20 is provided on second social network to communicate (48) with first social network and allow users 26 to access copyrighted content 14.

The application 20 may be any type of application that operates in accordance with the requirements of second social network. For example, application 20 may be a Facebook application developed by and provided by the second social network. In this example, application 20 makes use of the Facebook Application Programming Interface (API). Application 20 may be, for example, more generally a post or code that creates a post on any website having social networking attributes, such as livejournal.com. The post may include a link to content, for example, a link to copyrighted content 14 of first social network 12.

Turning now to FIG. 2, a method for distributing and paying for content is shown. For clarity, occasional reference is made to FIG. 1. In disclosing the method, the reference numbers shown below in parentheses refer to elements of FIG. 1. It is understood that although the steps of FIG. 2 are shown in a particular order, the steps may be executed in a different order, or in parallel. For example, a user could donate money 104 without downloading 102, or before downloading 102. Additionally, content may be provided 100 while a user is downloading 102, or while a user is sharing 106, or while a user is paying 104.

At step 100, content is provided, at least some of it copyrighted content. The content is owned by a content creator (28). The content is stored in a database (14) of a first social network (12).

At step 102, a user (26) downloads the content by way of an application (20) executing on a server (22) of a second social network (18). Alternatively, at step 102, the user (26) still downloads the content of the first social network (12), but the application executes on the server (16) of the first social network (12). For example, the user might click on a URI (Universal Resource Identifier) displayed via the second social network (18). And, by selecting the URI, database (14) is accessed for the purpose of downloading the content directly from first social network (12) to the user (26). In any case, the user accesses the first social network from the second social network.

At step 104, on a voluntary basis, the user electronically pays the content creator for the content. Referring back to FIG. 1, the user (26) pays the content creator (28) by way of (52) a payment system (32). Examples of payment systems include PayPal.com and WebMoney.com. This will be describe in additional detail below with reference to FIG. 3.

Turning to FIG. 2, at step 106, the user (26) shares at least some of the content with at least one additional user (not shown) of the second social network. For example, the user may share content such as album art, song names, audio samples, and the user's comments in order to entice the additional user(s) to download and listen to the music of the content creator. This is shown by arrow 107, whereby the additional user(s) repeat the step of user downloading 102, optionally the step of paying the content creator 104, and optionally the step of sharing with at least some additional users 106.

As indicated by dashed arrow 105, the user may download 102 additional content (14). The additional content may be freely available to any user of the second social network (18), or the additional content may comprise content only available to user's who paid the content creator 104, or the additional content may comprise content only available to a user who shared the content with many additional users 106, and those additional users downloaded content 102 or paid the content creator 104, or shared the content 106 with many other users.

Referring briefly back to FIG. 1, records of which users shared content, recommended content, paid the content creator, and caused others to pay the content creator are stored and processed by server 16 of social network 12.

FIG. 3 shows a method for performing a step of paying a content creator, that is, the steps of step 104 of FIG. 2.

At step 200, an electronic request is transmitted from the user (26) to the application (20, 22) of the second social network (18). The electronic request includes an electronic identifier of the owner of the content creator and the amount of the payment.

At step 202, the electronic request is transmitted to the first social network. The first social network stores all information for the content creator to be paid, such as account information.

At step 204 the electronic request is transmitted from the first social network to an electronic payment system (34). The request is transmitted via the network, as described above (38, 10, and 26).

At step 206, at the payment system (32), the electronic request is received and money is deposited (52) from the user (24), such as a bank account or credit account of the user, to an account of the content creator (28). The first social network (12) may keep a portion of the payment and pay the balance to the content creator (28).

Thus, content on a first social network is promoted and distributed for free on a second social network having a large number of users, the content creator is paid by those using or enjoying the content, the most prolific or generous users are rewarded by the content creator for their efforts or donations.

FIG. 4 show an exemplary webpage displayed on a web browser of a user (26 of FIG. 1). As can now be understood by referring to FIG. 4 and the above disclosure, the user accesses the second social network (18 of FIG. 1) and is shown content (14 of FIG. 1) of the first social network (12 of FIG. 1). In the example of FIG. 4, the second social network is Facebook. The webpage comprises all of the components disclosed above, including content from the first social network 400, a link to download content 402, link to share the content 404 on the second social network. Also shown is a link to pay the content creator 406 via the first social network and an electronic payment system. In this example, the electronic payment system is PayPal. Also shown is information 408 stored and maintained by server (16 of FIG. 1) concerning content sharing, and the like.

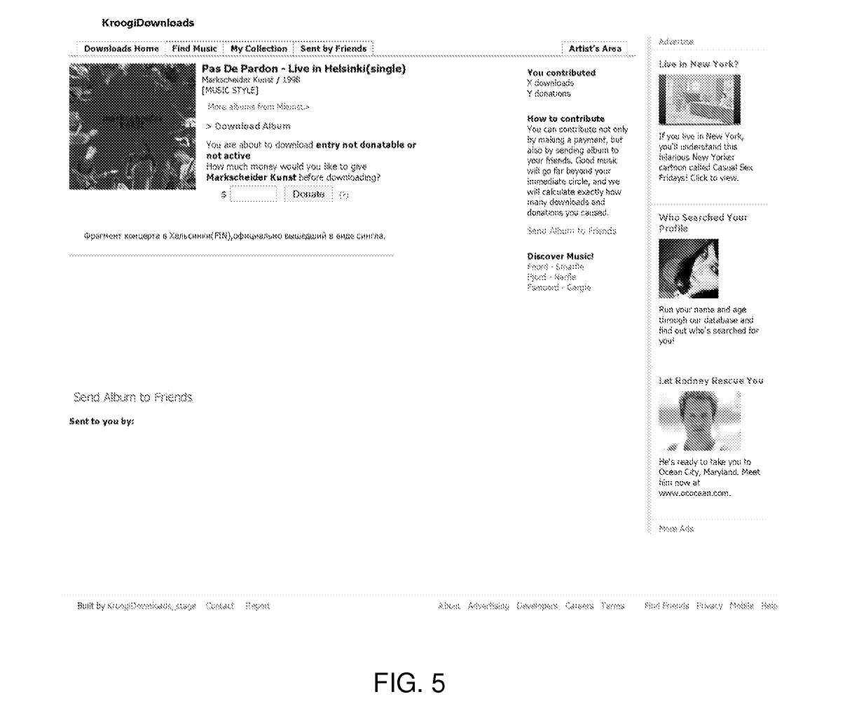

FIG. 5 shows an exemplary screenshot of a webpage as described with reference to FIG. 4. In this example, the first social network is kroogi.com and the content is music.

The foregoing detailed description has discussed only a few of the many forms that this invention can take. It is intended that the foregoing detailed description be understood as an illustration of selected forms that the invention can take and not as a definition of the invention. It is only in the claims, including all equivalents, that are intended to define the scope of this invention.

What is claimed is:

1. A method for distributing content on social networks, the method comprising:
providing copyrighted content on a first social network;
executing an application on a second social network; and
downloading the copyrighted content by way of the application on the second social network.

2. The method of claim 1 further comprising, from the second social network, electronically sharing the copyrighted content of the first social network with another user of the second social network.

3. The method of claim 1 further comprising, from the second social network, electronically paying a creator of the copyrighted content on the first social network.

4. The method of claim 1 wherein the step of electronically paying comprises:
transmitting an electronic request from the second social network to the first social network; and
transmitting the electronic request to an electronic payment system, wherein the electronic request causes the electronic payment system to deposit money into an account of a creator of the copyrighted content on the first social network.
